(19) United States
(12) Patent Application Publication
(10) Pub. No.: US 2012/0262603 A1
(43) Pub. Date: Oct. 18, 2012

(54) Image Capturing Device and Image Processing Method Thereof

(75) Inventors: Kuo-Chang Chen, Zhubei City (TW); Yung-Tsung Wang, Taichung City (TW)

(73) Assignee: ALTEK CORPORATION, Hsinchu (TW)

(21) Appl. No.: 13/187,041

(22) Filed: Jul. 20, 2011

(30) Foreign Application Priority Data
Apr. 12, 2011 (TW) 100112655

(51) Int. Cl. H04N 5/76

(52) U.S. Cl. 348/231.99; 348/E05.024

(57) ABSTRACT

An image capturing device and an image processing method thereof are disclosed. The image capturing device comprises an image capturing module, a storage module and a processing module. The processing module, comprising a plurality of buffers, controls the image capturing module to capture the first image data, saves the first image data in the plurality of buffers sequentially, conducts image processing correspondingly, and generates processed data. Soon, the processing module conducts an image compression on the processed data and saves the processed data in the storage module. In addition, while conducting the image compression, the processing module controls the image capturing module to capture the second image data, saves the first image data in the plurality of buffers sequentially, and conducts image processing correspondingly.

### BACKGROUND OF THE INVENTION

1. Field of the Invention

The present invention relates to an image capturing device and an image processing method thereof, and more particularly to an image capturing device and an image processing method thereof capable of enhancing the overall continuous shooting performance.

2. Description of Related Art

In our daily life, various digital products substituting for the traditional analog technologies have become very popular nowadays, and a digital camera is a good example of the digital products. In the digital camera, an optical sensor is used to capture analog signal corresponding to a scene and the analog signal is then converted into digital data for further several image processes. The proceeded digital data finally is saved as an image file in an electronic photo file format. At present, a static image compression standard (Joint Photographic Experts Group, JPEG) is one of the popular image file formats, and has been used in most digital cameras or other digital products.

The requirement for a high-performance continuous shooting of a digital camera becomes increasingly stricter. To enhance the overall continuous shooting performance, the common ways are nothing more than raising execution clock of hardware or using an efficient system flow for the control. However, raising the hardware clock has limits, so that the possible improvement can be generally made by controlling the system flow efficiently.

In conventional image processing procedure for continuous shooting, the image processing for the next shooting must keep waiting after the previous processed file is saved. In other words, in the JPEG image processing procedure which performs the JPEG image process on the data stored in the YCbCr color space buffer and saves the processed data as a file, the action to capture next image data must wait unit the processing procedure for the previous image data is completed. Therefore, the image processing time for the continuous shooting will affect the continuous shooting performance. In other words, the overall continuous shooting performance will be affected by the size of the JPEG files or the processing time or writing speed of the memory card. Once if the related processing time becomes long, the continuous shooting performance will be dropped correspondingly.

What is needed is to design an image capturing device and its image processing method to enhance the overall continuous shooting performance of a digital camera demands immediate attentions and feasible solutions.

### SUMMARY OF THE INVENTION

In view of the aforementioned shortcomings of the prior art, it is a primary objective of the invention to provide an image capturing device and its image processing method to overcome the low performance of continuous shooting caused by the delay of the image processing speed in present image capturing applications.

To achieve the foregoing objective, the present invention provides an image capturing device, comprising an image capturing module, a storage module and a processing module. The image capturing module is provided for capturing a plurality of images. The storage module is provided for saving the plurality of images. The processing module includes a plurality of buffers, and the processing module controls the image capturing module to capture first image data, saves the first image data in the plurality of buffers sequentially, and conducts image processing correspondingly to generate processed data. The processing module conducts an image compression on the processed data and saves the processed data in the storage module. While the processing module is conducting the image compression, the processing module controls the image capturing module to capture second image data and saves the second image data in the plurality of buffers sequentially to conduct image processing correspondingly.

The processing module includes a plurality of buffers, and the processing module for controlling the image capturing module to capture first image data, saving the plurality of buffers, conducting image processing correspondingly to generate processed data, conducting an image compression on the processed data, and saving the processed data in the storage module; wherein while the processing module is conducting an image compression, the processing module controls the image capturing module to capture second image data, saves the second image data in the plurality of buffers sequentially, and conducts image processing correspondingly.

Wherein, the plurality of buffers include a color filter array (CFA) buffer, and the processing module saves the first image data in the CFA buffer, conducts image processing to filter red, green and blue lights, and generates temporary data.

Wherein, the plurality of buffers include a first YCbCr color space buffer and a second YCbCr color space buffer, and the processing module saves the temporary data in the first YCbCr color space buffer or the second YCbCr color space buffer, conducts image processing of brightness or chromatic aberration, and generates the processed data.

Wherein, the processing module conducts image processing to compress the processed data based on a static image compression standard (Joint Photographic Experts Group, JPEG).

To achieve the foregoing objective, the present invention further provides an image capturing device, comprising an image capturing module capturing a plurality of images; a storage module saving the plurality of images; and a plurality of buffers; means for controlling the image capturing module to capture a first image data, saving the first image data in the plurality of buffers sequentially, conducting image processing correspondingly to generate a processed data, conducting an image compression on the processed data, and saving the processed data in the storage module; and means for controlling the image capturing module to capture a second image data, saving the second image data in the plurality of buffers sequentially, and conducting image processing correspondingly while the image compression is conducting.

Wherein, the plurality of buffers may include a color filter array (CFA) buffer, and the first image data is saved in the CFA buffer for further image processing to filter red, green and blue lights, and generate a temporary data.

Wherein, the plurality of buffers include a first YCbCr color space buffer and a second YCbCr color space buffer, and the temporary data is saved in the first YCbCr color space buffer or the second YCbCr color space buffer for further conduct image processing of brightness or chromatic aberration, and to generate the processed data.

Wherein, the processed data is compressed based on a static image compression standard (Joint Photographic Experts Group, JPEG).

To achieve the foregoing objective, the present invention further provides an image processing method applicable to an image capturing device, and the image capturing device includes an image capturing module, a storage module and a processing module, and the processing module includes a plurality of buffers, and the image processing method comprises the steps of: capturing first image data by the image capturing module; saving the first image data in the plurality of buffers sequentially, conducting image processing correspondingly, and generating processed data; conducting an image compression on the processed data by the processing module and saving the processed data in the storage module; and capturing second image data by the image capturing module, while the processing module is conducting the image compression on the processed data, and then repeating the aforementioned saving and processing steps.

Wherein, the present invention image processing method further comprises the step of: using the processing module to save the first image data in a CFA buffer of the plurality of buffers, conduct image processing to filter red, green and blue lights, and generate temporary data.

Wherein, the present invention image processing method further comprises the step of: using the processing module to save the temporary data in a first YCbCr color space buffer or a second YCbCr color space buffer of the plurality of buffers, conduct image processing of brightness or chromatic aberration, and generate the processed data.

Wherein, the present invention image processing method further comprises the step of: using the processing module to conduct image processing to compress the processed data based on a static image compression standard (Joint Photographic Experts Group, JPEG).

Wherein, the plurality of buffers comprises a first buffer, a second buffer and a third buffer, and the image processing method further comprises steps of: saving the first image data in the first buffer; conducting a first image processing on the first image data to obtain a first temporary data; saving the first temporary data in the second buffer or the third buffer; conducting a second image processing on the first temporary data to obtain a second temporary data; using the processing module to conduct the image compression on the second temporary data, and save the second temporary data in the storage module; and using the image capturing module to capture the second image data while the processing module is conducting the image compression, and then repeating said saving and processing steps.

Wherein, the first buffer is a color filter array (CFA) buffer, and the processing module saves the first image data in the CFA buffer, conducts image processing to filter red, green and blue lights, and generates first temporary data.

Wherein, the second buffer and third buffer are a first YCbCr color space buffer and a second YCbCr color space buffer respectively, and the processing module saves the first temporary data in the first YCbCr color space buffer or the second YCbCr color space buffer, conducts image processing of brightness or chromatic aberration, and generates second temporary data.

Wherein, the present invention image processing method further comprises the step of using the processing module to conduct image processing to compress the second temporary data based on a static image compression standard (Joint Photographic Experts Group, JPEG).

In summation, the image capturing device and the image processing method thereof in accordance with the present invention have the following advantages:

In the image capturing device and the image processing method thereof, the time-consuming JPEG image processing procedure is deemed an individual processing procedure, such that after the processing procedure is initialized, the image capturing device can continue conducting the next shooting process to generate data immediately without the need of waiting for the completion of saving the JPEG images. Therefore, the image processing time of two successive continuously taken photos will not be affected by the file writing speed, so as to achieve the effect of enhancing the overall continuous shooting performance of the digital camera.

### BRIEF DESCRIPTION OF THE DRAWINGS

FIG. 1 is a block diagram of an image capturing device in accordance with a preferred embodiment of the present invention;

FIG. 2 is a schematic view of an image capturing device in accordance with a preferred embodiment of the present invention;

FIG. 3 is a schematic view of image processing of an image capturing device in accordance with a preferred embodiment of the present invention;

FIG. 4 is a schematic view of continuous shooting results of an image capturing device in accordance with a preferred embodiment of the present invention;

FIG. 5 is a schematic view of an electronic device with an image capturing function in accordance with a preferred embodiment of the present invention; and

FIG. 6 is a flow chart of an image processing method of the present invention.

### DETAILED DESCRIPTION OF THE PREFERRED EMBODIMENTS

The technical contents and characteristics of the image capturing device and its image processing method in accordance with the present invention will be apparent with the detailed description of a preferred embodiment accompanied with related drawings as follows. For simplicity, same numerals are used in the following preferred embodiment to represent respective same elements.

The image capturing device of the present invention can be a digital camera, a camera phone, a Smartphone, a digital video camera, or any other portable electronic device with a photographing function. For convenience, the Smartphone is used in the following preferred embodiment to describe the technical characteristics of the present invention, but the invention is not limited to such application only.

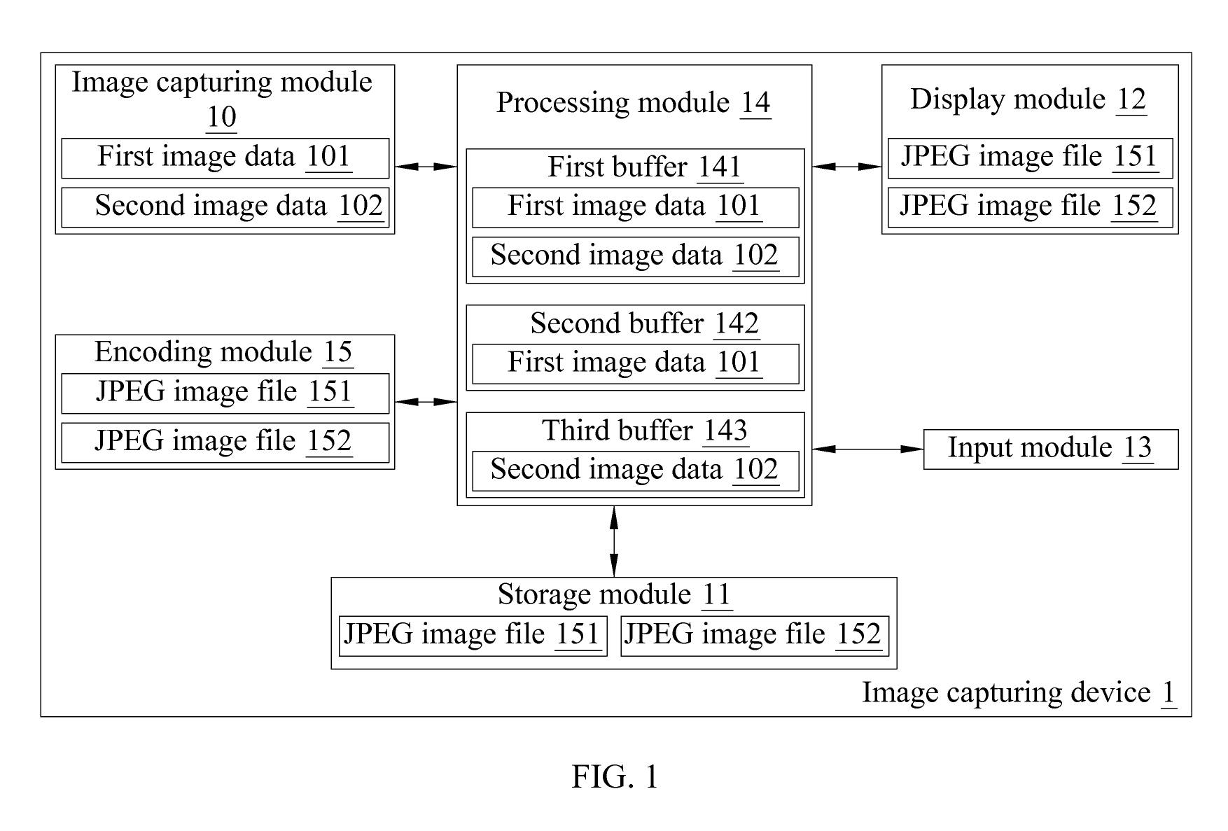

With reference to FIG. 1 for a block diagram of an image capturing device in accordance with a preferred embodiment of the present invention, the image capturing device 1 comprises an image capturing module 10, a storage module 11, a display module 12, an input module 13, a processing module 14 and an encoding module 15. The image capturing module 10 is provided for capturing an image and generating image data; the image capturing module 10 includes a lens, a light sensing component such as a complementary metal oxide semiconductor (CMOS) or a charge coupled device (CCD), an analog/digital circuit and an image processor, etc. The storage module 11 is provided for storing an image, and it can be an embedded memory, an external memory card or a combination of the two. The display module 12 is provided for displaying an image and can be a liquid crystal display (LCD) or an LCD touch screen.

The processing module 14 is electrically coupled to the image capturing module 10, the storage module 11, the display module 12, the input module 13 and the encoding module 15 and can be a central processing unit (CPU) or a micro-processing unit. The processing module 14 includes a first buffer 141, a second buffer 142 and a third buffer 143; wherein the first buffer 141, the second buffer 142 and the third buffer 143 are a color filter array (CFA) buffer, a first YCbCr color space buffer and a second YCbCr color space buffer respectively. The processing module 14 can set the image capturing device 1 to a continuous shooting mode according to a signal inputted from the input module 13. If the image capturing device 1 is set to a continuous shooting mode for capturing images, the processing module 14 can control the image capturing module 10 to capture first image data 101 and save the first image data 101 in the first buffer 141 (which is a CFA buffer) for conducting image processing to filter red (R), green (G) and blue (B) lights.

The processing module 14 can save the processed first image data 101 of the first buffer 141 (which is CFA buffer) in the second buffer 142 (which is a first YCbCr color space buffer) to conduct image processing of brightness or chromatic aberration. The processing module 14 can further control the encoding module 15 to process the first image data 101 which has gone through the brightness or chromatic aberration processing procedure based on a static image compression standard (Joint Photographic Experts Group, JPEG) to generate a JPEG image file 151, and save the JPEG image file 151 in the storage module 11.

While the encoding module 15 is conducting the JPEG image processing procedure on the first image data 101 which has gone through the brightness or chromatic aberration processing procedure, the processing module 14 can control the image capturing module 10 to capture second image data 102 and save the second image data 102 in the first buffer 141 (which is a CFA buffer) to conduct image processing to filter the red, green and blue lights. Similarly, the processing module 14 can save the processed second image data 102 of the first buffer 141 (which is a CFA buffer) in the third buffer 143 (which is a second YCbCr color space buffer) to process the brightness or chromatic aberration of the images. The processing module 14 further controls the encoding module 15 to conduct the JPEG image processing on the second image data 102 that has gone through the brightness or chromatic aberration processing procedure to generate another JPEG image file 152, and saves the JPEG image file 152 in the storage module 11. The processing module 14 can control the display module 12 to display the JPEG image files 151, 152 sequentially.

From the description above, while the encoding module 15 is conducting the JPEG image processing procedure on the previous image data, the processing module 14 can control the image capturing module 10 to capture the next image data and conduct image processing about the three primary colors RGB and image processing of brightness or chromatic aberration on the next image data. In other words, the image capturing device of the present invention can continue shooting next images to generate data without waiting for the completion of saving the current JPEG image file. Therefore, the time for shooting two successive images will not be affected by the speed of compressing files or writing files. Further, the persons skilled in the art can combine the aforementioned functional modules into an integrated module or separate the functional modules into different detailed functional units according to actual application conditions.

Besides, all those skilled in the art may randomly combine the functional modules into an integrated means or divide them into each detailed functional means, depending on the convenience of design.

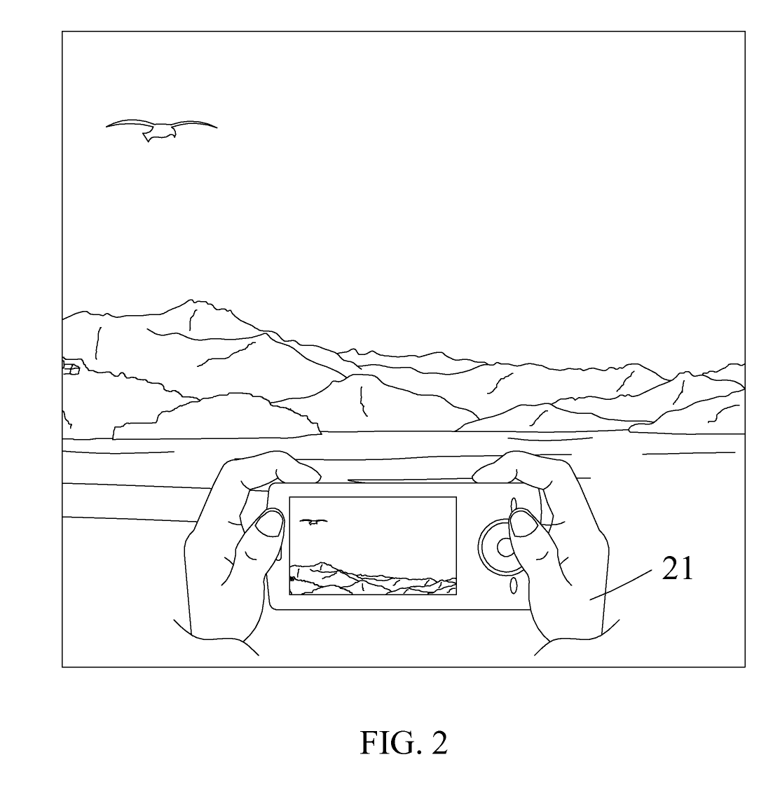

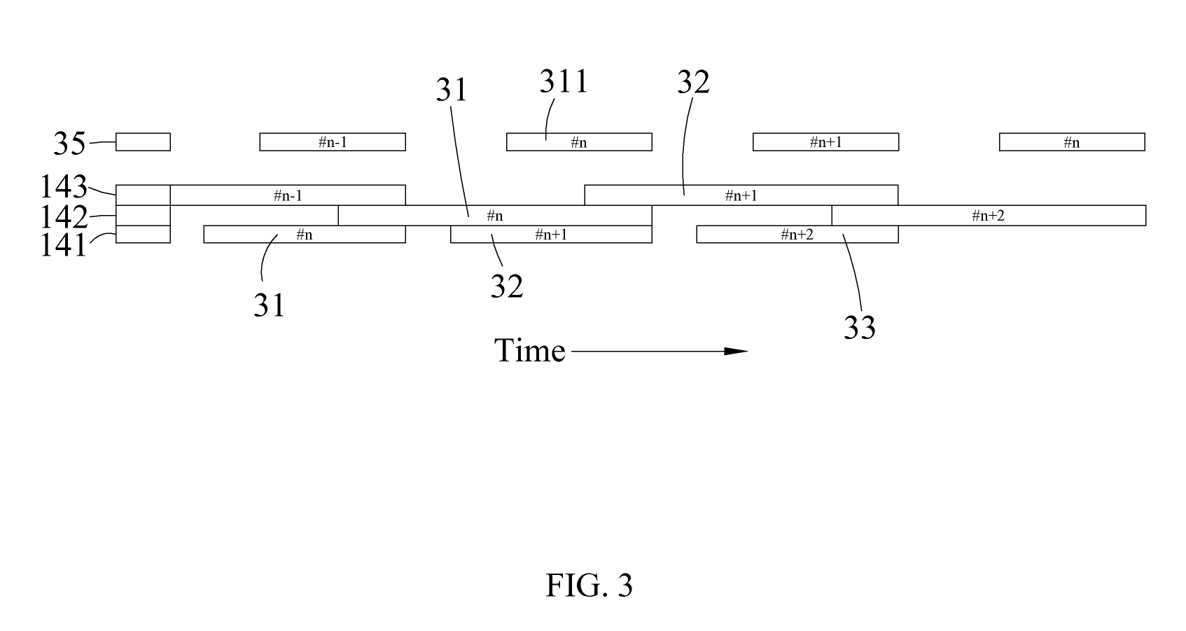

With reference to FIG. 2 for a schematic view of an image capturing device in accordance with a preferred embodiment of the present invention, a user 21 can set or input an instruction to activate an image continuous shooting mode by a touch screen of a Smartphone, and use the Smartphone to take the pictures of a flying bird. Therefore, when the user 21 presses the shutter to take pictures continuously, the image capturing module 10 can record the captured image data in the CFA buffer 141, wherein the CFA buffer 141 conforms to the Bayer pattern, and conducts the image processing of filtering lights of the three primary colors: red (R), green (G) and blue (B). With reference to FIG. 3 for a schematic view of image processing of an image capturing device in accordance with a preferred embodiment of the present invention, the processing module 14 can save the n^{th} image data 31 processed in the CFA buffer 141 in the first YCbCr color space buffer 142, conduct image processing to convert digital RGB signals into digital brightness and chromatic aberration signals. Wherein, the procedure that capturing the n^{th} image data 31 and saving the n^{th} image data 31 in the first YCbCr color space buffer 142 to conduct image processing to convert digital RGB signals into digital brightness and chromatic aberration signals is defined as a first job processing procedure in this preferred embodiment.

The processing module 14 can control the encoding module 15 to conduct a second job processing procedure that conducting an JPEG image processing procedure 35 to convert and process the brightness and chromatic aberration of the n^{th} image data 31 to generate a JPEG image file 311 of the n^{th} image data; and saving the JPEG image file 311 to of the n^{th} image data in the storage module 11. While the encoding module 15 is conducting the second job processing procedure, the processing module 14 can control the image capturing module 10 to capture the (n+1)^{th} image data 32, record the captured (n+1)^{th} image data 32 in the CFA buffer 141, and conduct image processing to filter the lights of the three primary colors: red (R), green (G) and blue (B).

Similarly, the processing module 14 can save the (n+1)^{th} image data 32 processed in the CFA buffer 141 in the second YCbCr color space buffer 143 to conduct image processing to convert the digital RGB signals into the digital brightness and chromatic aberration signals. In other words, the processing module 14 can save the image data processed in the CFA buffer 141 in the YCbCr color space buffer capable of processing the brightness and chromatic aberration conversion immediately (In this preferred embodiment, the processing module 14 can save the image data processed by the CFA buffer 141 in the YCbCr color space buffers 142, 143 alternately, but the practical application of the present invention is not limited to such arrangement only). When the processing module 14 controls the encoding module 15 to conduct the second processing procedure on the (n+1)^{th} image data 32, the processing module 14 can control the image capturing module 10 again to capture the (n+2)^{th} image data 33. The processing module 14 can save the JPEG image files processed by the JPEG image processing in the storage module 11 sequentially, and display the JPEG image files on the display module 12 sequentially and quickly.

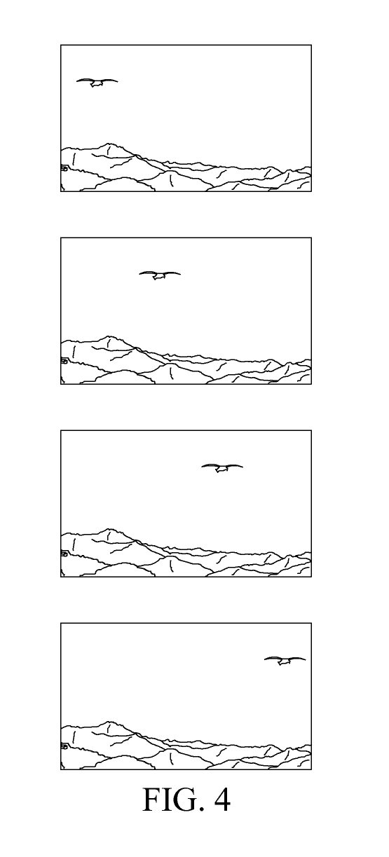

With reference to FIG. 4 for a schematic view of continuous shooting results of an image capturing device in accordance with a preferred embodiment of the present invention, the photos of a flying bird continuously taken by a user are shown. Since the image capturing device of the present invention deems the most time-consuming JPEG image processing procedure an individual job processing procedure, at the moment of the second job processing procedure starting, the first job processing procedure can continue taking the next photo to generate data, without the need of waiting for the completion of saving the JPEG files. The job of saving the JPEG files is taken over by the second job processing procedure and conducted independently. Therefore, the image processing time of two successive taken photos will not be affected by the file compression or the file writing speed, so as to achieve the effect of enhancing the continuous shooting performance.

It is noteworthy to point out that persons ordinarily skilled in the art should be able to understand that the arrangements of saving the image data in the CFA buffer and the YCbCr color space buffer and processing the image data by the JPEG image processing are examples of illustrating the present invention only. The invention is not limited to such arrangements.

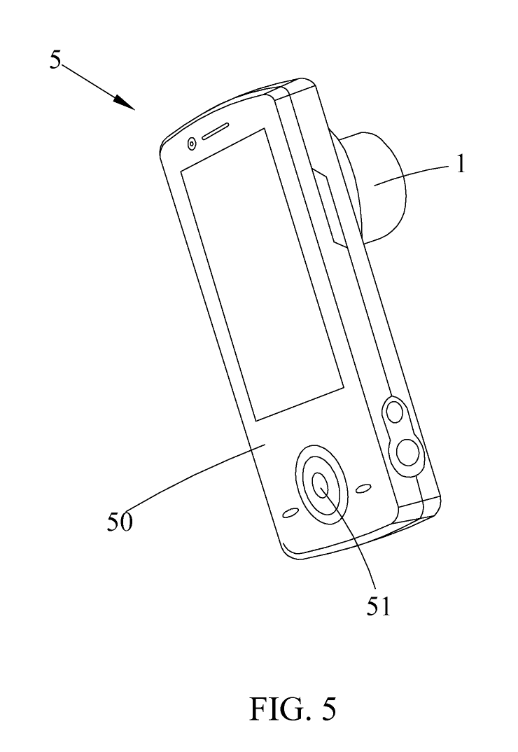

With reference to FIG. 5 for a schematic view of an electronic device with an image capturing function in accordance with a preferred embodiment of the present invention, the electronic device 5 comprises a main body 50, an input device 51 and an image capturing device 1. The image capturing device 1 is installed on the main body 50 and electrically coupled to the input device 51. The image capturing device 1 comprises an image capturing module, a storage module, a display module, an input module, a processing module and an encoding module. In this preferred embodiment, the electronic device 5 is a Smartphone having an embedded image capturing device 1 of the invention and used for taking pictures. when a user inputs signals to control the Smartphone to continuously takes pictures by touch screen or buttons of the input device 51 of the Smartphone, the electronic device 5 starts foregoing image processing procedure immediately such as capturing images, accessing the buffers sequentially and conducting related image processing procedures. According to the foregoing processing procedure, the first job processing procedure and the second job processing procedure can be carried out simultaneously to enhance the continuous shooting performance significantly. The Smartphone disclosed in this preferred embodiment is provided for the purpose of describing the present invention, but not intended for limiting the scope of the invention. Persons ordinarily skilled in the art should be able to replace the Smartphone by other devices to operate with the image capturing device of the present invention.

In the description of the image capturing device of the present invention, the concept of the image processing method of the present invention has also been described already. However, a flow chart is provided for the detailed description as follows.

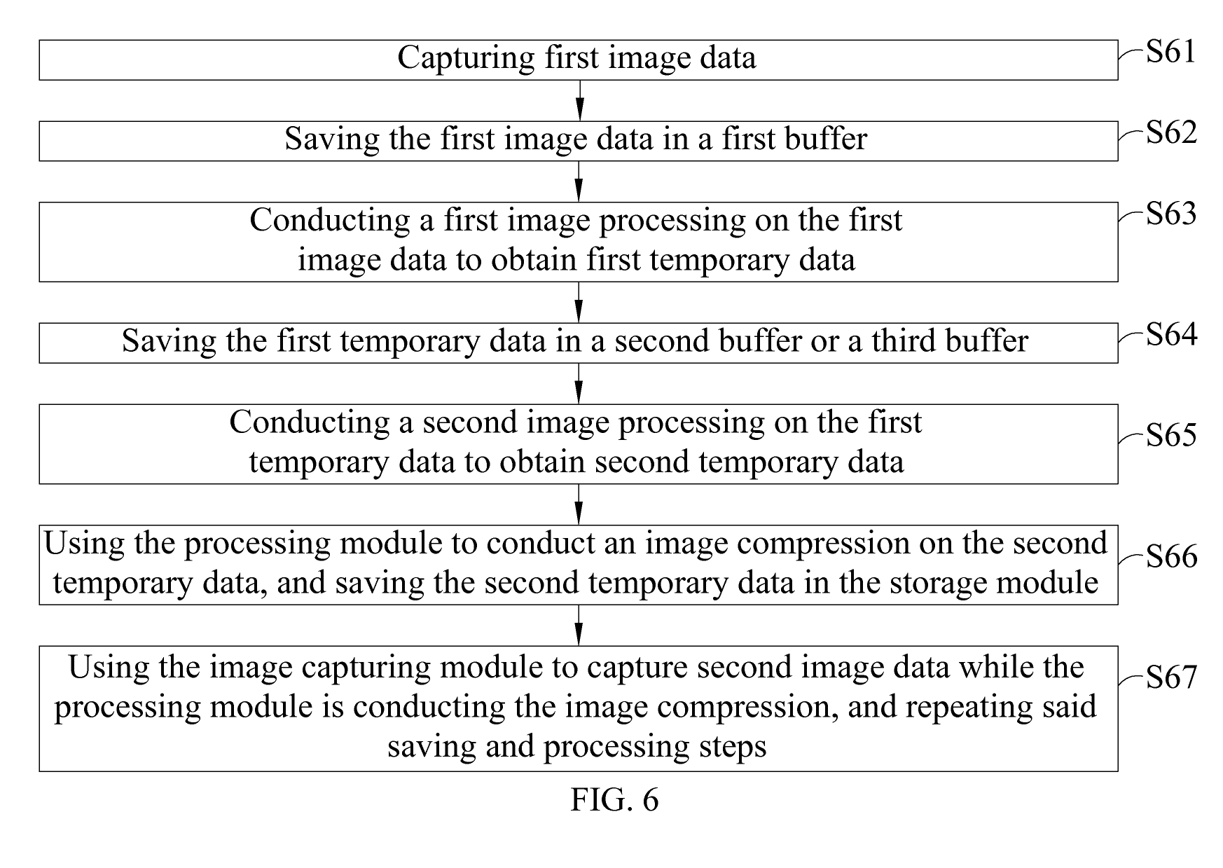

With reference to FIG. 6 for a flow chart of an image processing method of the present invention, the image processing method is applicable for an image capturing device, and the image capturing device comprises an image capturing module, a storage module, a display module, an input module, a processing module and an encoding module. The image processing method of the image capturing device comprises the following steps: In Step (S61), capturing first image data by the image capturing module. In Step S62, saving the first image data in the first buffer. In Step S63, conducting a first image processing on the first image data to obtain first temporary data. In Step S64, saving the first temporary data in the second buffer or the third buffer. In Step S65, conducting a second image processing on the first temporary data to obtain second temporary data. In Step S66, conducting an image compression on the second temporary data by the processing module and saving the second temporary data in the storage module by the processing module. In Step S67, capturing second image data by the image capturing module while the processing module is conducting the image compression, and repeating the aforementioned saving and processing steps.

The detailed description and implementation of the image processing method of the image capturing device in accordance with the present invention have already been described in the image capturing device and electronic device of the present invention, and thus will not be described here again.

In summation of the description above, the image capturing device and the image processing method thereof in accordance with the present invention deem the most time-consuming JPEG image processing procedure an individual processing procedure, such that at the moment of the processing procedure being initialized, the image capturing device can continue conducting the next continuous shooting process to generate data immediately without the need of waiting for the completion of saving the JPEG images. Therefore, the image processing time of two successive taken photos will not be affected by the file writing speed, so as to achieve the effect of enhancing the overall continuous shooting performance of the digital camera.

What is claimed is:

1. An image capturing device, comprising:
an image capturing module capturing a plurality of images;
a storage module saving the plurality of images; and
a processing module including a plurality of buffers, and the processing module being provided for controlling the image capturing module to capture a first image data, saving the first image data in the plurality of buffers sequentially, conducting image processing correspondingly to generate a processed data, conducting an image compression on the processed data, and saving the processed data in the storage module;
wherein while the processing module is conducting the image compression, the processing module controls the image capturing module to capture a second image data, saves the second image data in the plurality of buffers sequentially, and conducts image processing correspondingly.

2. The image capturing device of claim 1, wherein the plurality of buffers include a color filter array (CFA) buffer, and the processing module saves the first image data in the CFA buffer, conducts image processing to filter red, green and blue lights, and generates a temporary data.

3. The image capturing device of claim 2, wherein the plurality of buffers include a first YCbCr color space buffer and a second YCbCr color space buffer, and the processing module saves the temporary data in the first YCbCr color space buffer or the second YCbCr color space buffer to conduct image processing of brightness or chromatic aberration, and generates the processed data.

4. The image capturing device of claim 1, wherein the processing module conducts image processing to compress the processed data based on a static image compression standard (Joint Photographic Experts Group, JPEG).

5. An image capturing device, comprising:
an image capturing module capturing a plurality of images;
a storage module saving the plurality of images; and
a plurality of buffers;
means for controlling the image capturing module to capture a first image data, saving the first image data in the plurality of buffers sequentially, conducting image processing correspondingly to generate a processed data, conducting an image compression on the processed data, and saving the processed data in the storage module; and
means for controlling the image capturing module to capture a second image data, saving the second image data in the plurality of buffers sequentially, and conducting image processing correspondingly while the image compression is conducting.

6. The image capturing device of claim 5, wherein the plurality of buffers include a color filter array (CFA) buffer, and the first image data is saved in the CFA buffer for further image processing to filter red, green and blue lights, and generate a temporary data.

7. The image capturing device of claim 6, wherein the plurality of buffers include a first YCbCr color space buffer and a second YCbCr color space buffer, and the temporary data is saved in the first YCbCr color space buffer or the second YCbCr color space buffer for further conducting image processing of brightness or chromatic aberration, and to generate the processed data.

8. The image capturing device of claim 5, wherein the processed data is compressed based on a static image compression standard (Joint Photographic Experts Group, JPEG).

9. An image processing method applied to an image capturing device, and the image capturing device comprising an image capturing module, a storage module and a processing module, and the processing module comprising a plurality of buffers, and the image processing method comprising the steps of:
capturing a first image data by the image capturing module;
saving the first image data in the plurality of buffers sequentially, conducting image processing correspondingly, and generating a processed data;
using the processing module to conduct an image compression on the processed data and save the processed data in the storage module; and
capturing a second image data by the image capturing module while the processing module is conducting an image compression on the processed data, and then repeating said saving and processing steps.

10. The image processing method of claim 9, further comprising the step of:
using the processing module to save the first image data in a color filter array (CFA) buffer of the plurality of buffers, conduct image processing to filter red, green and blue lights, and generate a temporary data.

11. The image processing method of claim 10, further comprising the step of:
using the processing module to save the temporary data in a first YCbCr color space buffer or a second YCbCr color space buffer of the plurality of buffers, conduct image processing of brightness or chromatic aberration, and generate the processed data.

12. The image processing method of claim 9, further comprising the step of:
using the processing module to conduct image processing to compress the processed data based on a static image compression standard (Joint Photographic Experts Group, JPEG).

13. The image processing method of claim 9, wherein the plurality of buffers comprising a first buffer, a second buffer and a third buffer, and the image processing method further comprising steps of:
saving the first image data in the first buffer;
conducting a first image processing on the first image data to obtain a first temporary data;
saving the first temporary data in the second buffer or the third buffer; and
conducting a second image processing on the first temporary data to obtain a second temporary data;
using the processing module to conduct the image compression on the second temporary data, and save the second temporary data in the storage module; and
using the image capturing module to capture the second image data while the processing module is conducting the image compression, and then repeating said saving and processing steps.

14. The image processing method of claim 13, wherein the first buffer is a color filter array (CFA) buffer, and the processing module saves the first image data in the CFA buffer, conducts image processing to filter red, green and blue lights, and generate the first temporary data.

15. The image processing method of claim 14, wherein the second buffer and the third buffer are a first YCbCr color space buffer and a second YCbCr color space buffer respectively, and the processing module saves the first temporary data in the first YCbCr color space buffer or the second YCbCr color space buffer, conducts image processing of brightness or chromatic aberration, and generates the second temporary data.

16. The image processing method of claim 13, further comprising the step of:
using the processing module to conduct image processing to compress the second temporary data based on a static image compression standard (Joint Photographic Experts Group, JPEG).
